(19) United States
(12) Patent Application Publication
(10) Pub. No.: US 2007/0106657 A1
(43) Pub. Date: May 10, 2007

(54) Word sense disambiguation

(76) Inventors: Vadim Von Brzeski, San Jose, CA (US); Reiner Kraft, Gilroy, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/270,917

(22) Filed: Nov. 10, 2005

(51) Int. Cl. G06F 17/30

(52) U.S. Cl. 707/5

(57) ABSTRACT

Techniques for automatically disambiguating a term with multiple meanings are provided. Term disambiguation is based on both training data and the contents of the body of text in which the term occurs. Once the contextual meaning of a term has been determined, metadata associated with that term can be used to narrow the scope of an automated search. Consequently, documents that contain the term in a context other than the context of the body of text can be excluded from search results. User interface elements may be associated with selected key terms in a web page. User interface elements associated with key terms may be associated with the contextual meanings of those key terms. When such an element is activated, metadata associated with the meaning of the corresponding key term may be submitted to a search engine, which can use the metadata to focus a search for pertinent documents.

### CROSS-REFERENCE TO RELATED APPLICATIONS

The present application is related to U.S. patent application Ser. No. 10/903,283, titled “SEARCH SYSTEMS AND METHODS USING IN-LINE CONTEXTUAL QUERIES,” filed on Jul. 29, 2004, by Reiner Kraft, the contents of which patent application are incorporated by reference in their entirety for all purposes, as though originally disclosed herein.

### FIELD OF THE INVENTION

The present invention relates to data processing and, more specifically, to disambiguating the meaning of a word that is associated with multiple meanings.

### BACKGROUND

Search engines that enable computer users to obtain references to web pages that contain one or more specified words are now commonplace. Typically, a user can access a search engine by directing a web browser to a search engine “portal” web page. The portal page usually contains a text entry field and a button control. The user can initiate a search for web pages that contain specified query terms by typing those query terms into the text entry field and then activating the button control. When the button control is activated, the query terms are sent to the search engine, which typically returns, to the user's web browser, a dynamically generated web page that contains a list of references to other web pages that contain the query terms.

Unfortunately, the list of references may include references to web pages that have little or nothing to do with the subject in which the user is interested. For example, the user might have been interested in reading web pages that pertain to Madonna, the pop singer. Thus, the user might have submitted the single query term, “Madonna.” Under such circumstances, the list of references might include references not only to Madonna, the pop singer, but also to the Virgin Mary, who is also sometimes referred to as “Madonna.” The user is likely not interested in the Virgin Mary, and may be frustrated at being required to hunt through references that are not relevant to him in search of references that are relevant to him. Yet, if the user had instead submitted query terms “Madonna pop singer,” the resulting list of references might have omitted some highly relevant web pages in which the user likely would have been interested, but in which the query terms “pop” and/or “singer” did not occur.

U.S. patent application Ser. No. 10/903,283, filed on Jul. 29, 2004, discloses techniques for performing context-sensitive searches. According to one such technique, a “source” web page may be enhanced with user interface elements that, when activated, cause a search engine to provide search results that are directed to a particular key concept to which at least a portion of the “source” web page pertains. For example, such user interface elements may be “Y!Q” elements, which now appear in many web pages all over the Internet. For additional information on “Y!Q” elements, the reader is encouraged to submit “Y!Q” as a query term to a search engine.

A web page can be enhanced by modifying the web page to include such user interface elements. To do so, key concepts to which the web page pertains are determined. Different sections of a web page may pertain to different key concepts. Once the key concepts to which the web page pertains have been determined, the source code of the web page is modified so that the source code contains references to the user interface elements discussed above. In the source code, the key concepts that are associated with each user interface element are specified. After the source code has been modified in this manner, the user interface elements will appear on the web page.

Searches conducted via such a user interface element take into account the key concepts that have been associated with that user interface element. For example, the key concepts may be used as criteria that narrow search results. Results produced by such searches focus on web pages that specifically pertain to those key concepts, making those results context-specific.

However, the question arises as to how the key concepts to which a web page (or a portion thereof) pertains can be determined in the first place. A human being could manually decide the key concepts and manually modify the web page so that the web page comprises a user interface element that is associated with those key concepts. This becomes an onerous, time-consuming, and expensive task, though, when any more than just a few web pages need to be enhanced to enable context-sensitive searches as described above.

The possibility of determining the key concepts via automated means might be considered. For example, using a specified algorithm, a machine might attempt to automatically determine the most significant words in a web page, and then automatically select key concepts that have been associated with those words in a database. However, as is discussed above, some words, like “Madonna,” have multiple, vastly different meanings and definitions. The key concepts which ought to be associated with a particular word may vary extremely depending on the meaning of the word. Thus, where a particular word has multiple different meanings, the question arises as to how a machine can automatically select the most appropriate meaning from among the multiple meanings.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates an example of a technique for generating representative meaning vectors for a term, according to an embodiment of the invention;

FIG. 2 is a flow diagram that illustrates an example of a technique for performing a context-sensitive search based on a term for which there exist a plurality of representative meaning vectors, according to an embodiment of the invention; and

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

According to one embodiment of the invention, a term (e.g., a set of one or more words) with multiple different meanings is automatically “disambiguated” based on both training data and the contents of the body of text (e.g., a web page or a portion thereof) in which the word occurs. In this manner, the most likely “real” or “target” meaning of such a word can be determined with little or no human intervention.

For example, if the term in a paragraph on a web page is “Boston,” a determination may be automatically made, based on both training data and the text of the paragraph and/or web page in which the term occurs, whether the term means “Boston, the city” or “Boston, the band.” According to one embodiment of the invention, this determination may be made automatically even if the body of text in which the term occurs does not expressly indicate the meaning of the term (e.g., even if the web page in which “Boston” occurs does not contain the words “city” or “band”).

Once the real meaning of a word has been determined, metadata that has been associated with that word can be used to narrow the scope of an automated search for documents and/or other resources that pertain to the meaning of the word. Consequently, documents that might contain the word, but in a context other than the meaning of the word as contained in the body of text, can be excluded from results of a search for documents that pertain to the meaning of the word.

Through the application of one embodiment of the invention, context-sensitive search-enabling user interface elements, such as “Y!Q” elements, may be automatically associated with selected key terms in a web page. The user interface element associated with a particular key term may be automatically associated with the meaning of the particular key term as automatically determined using techniques described herein. For example, in a web page that contains the key term “Boston,” and which means “Boston, the city,” the user interface element displayed next to the key term “Boston” may be associated with hidden information that associates that interface element with the meaning “city.”

Thus, the meaning of the key term, in the context of the web page in which it occurs, is not ambiguous. When such a user interface element is activated, metadata that is associated with the meaning of the key term may be submitted to a search engine along with the key term. The search engine can use the metadata to focus a search for documents that contain the key term.

### Determining Possible Meanings of a Term

The technique described below may be performed for each key term contained in a web page, regardless of the approach used to decide which terms within a web page are significant enough to be deemed key terms for that web page.

According to one embodiment of the invention, multiple possible meanings of a term are determined. For each such meaning, a separate representative “seed phrase” is derived from the meaning. For example, if the term “Boston” can mean a city or a band, the seed phrases for the term “Boston” may include “city” and “band.” The several seed phrases corresponding to a term are used to generate a set of training data for that term, based on techniques described below.

In one embodiment of the invention, multiple possible meanings for a term may be generated using a manual or automated process. For example, to generate possible meanings for a term, the term may be submitted as a query term to an online dictionary or encyclopedia (one such online encyclopedia is “Wikipedia”). Each different entry returned by the online dictionary or encyclopedia may be used to derive a separate corresponding meaning and seed phrase.

### Generating Training Data for a Term

In one embodiment of the invention, for each seed phrase related to a term, a search query that is based on both the term and the seed phrase is automatically submitted to one or more search tools (e.g., a search engine). For example, the query terms submitted to a search tool may include both the term and the seed phrase. For another example, a search tool may limit the scope of a search for documents that contains the term to documents that previously have been placed in a category that corresponds to the seed phrase (e.g., a “bands” category or a “cities” category). One search tool that may be used to search for documents categorically is the “Open Directory Project,” for example.

For each seed phrase, the one or more search tools return a different set of results. Each set of results corresponds to a different meaning of the term. For each result, an association is established between that result and the seed phrase that contributed to the generation of that result. Consequently, it may be recalled, later, which seed phrase contributed to the generation of each result.

In one embodiment of the invention, each result is a Universal Resource Locator (URL). Each result corresponds to a result document to which the URL refers. Together, all of the result documents comprise the “training data” for the term. Thus, the training data for the term includes all of the result documents corresponding to results returned by the search tools, regardless of which seed phrases contributed to the inclusion of those result documents within the training data. Non-substantive information, such as HTML tags, may be automatically stripped from the training data.

In one embodiment of the invention, the efficiency of the techniques described herein is increased by automatically removing, from the training data (or otherwise eliminating from future consideration), all words that occur only once within the training data. Words that occur only once within all of the result documents typically are not very useful for disambiguating a term.

### Generating Context Meaning Vectors for Result Documents

According to one embodiment of the invention, for each result document in the training data, a separate context meaning vector is automatically generated for that result document. The context meaning vector may comprise multiple numerical values, for example. The context meaning vector generated for a result document is based upon the contents of that result document. Thus, the context meaning vector generated for a result document generally represents the contents of that result document in a more compact form. Typically, the more similar the contents of two documents are, the more similar the context meaning vectors of those documents will be. For each result document, an association is established between that result document and the context meaning vector for that result document.

In one embodiment of the invention, the context meaning vector for a result document is generated by applying the Latent Dirichlet Allocation (LDA) algorithm, or a variant thereof, to that result document. The LDA algorithm is disclosed in “Latent Dirichlet Allocation,” by D. Blei, A. Ng, and M. Jordan, in Journal of Machine Learning Research 3 (2003), the contents of which publication are incorporated by reference in their entirety for all purposes, as though originally disclosed herein. Alternative embodiments of the invention may apply other algorithms to result documents in order to generate context meaning vectors for those documents.

### Grouping Context Meaning Vectors

After context meaning vectors have been generated for each result document in the training data, context meaning vectors are grouped together into separate groups. In one embodiment of the invention, context meaning vectors are grouped together based on the seed phrases that were used to generate the result documents to which those context meaning vectors correspond. For example, all context meaning vectors for result documents located by submitting the seed phrase “city” to search tools may be placed in a first group, and all context meaning vectors for result documents located by submitting the seed phrase “band” to search tools may be placed in a second group.

### Generating Representative Meaning Vectors for Each Group

According to one embodiment of the invention, a separate representative meaning vector is automatically generated for each group of context meaning vectors. Different representative meaning vectors may be generated for different groups. The representative meaning vector for a group of context meaning vectors is generated based on all of the context meaning vectors in the group.

According to one embodiment of the invention, the representative meaning vector for a context meaning vector group is generated by averaging all of the context meaning vectors in that group. For example, if a group contains three context meaning vectors with values (1, 1, 8), (2, 1, 9), and (1, 3, 7), respectively, then the representative meaning vector for that group may be generated by averaging the first values of each of the context meaning vectors to produce the first value of the representative meaning vector, averaging the second values of the cf the context meaning vectors to produce the second value of the representative meaning vector, and averaging the third values of the context meaning vector to produce the third value of the representative meaning vector. In this example, the values of the representative meaning vector would be ((1+2+1)/3, (1+1+3)/3, (8+9+7)/3)), or approximately (1.3, 1.7, 8).

In one embodiment of the invention, each representative meaning vector is associated with the dominant seed phrase of the group on which that representative meaning vector is based. Each of the representative meaning vectors corresponds to the term based on which the training data was generated. Each of the representative meaning vectors corresponds to a different contextual meaning of the term.

### Generating a Context Meaning Vector for a Body of Text

After the training data has been processed as described above, the representative meaning vectors generated for a term can be compared to a context meaning vector for a body of text that contains the term to determine a contextual meaning of the term within the body of text. The same term within different bodies of text may have different contextual meanings. If the context meaning vector for a body of text that contains a term is similar to a representative meaning vector that corresponds to a particular contextual meaning of that term, then chances are good that the actual contextual meaning of the term within that body of text is the particular contextual meaning corresponding to that representative meaning vector.

In one embodiment of the invention, key terms in a web page are automatically determined. For example, a web browser may make this determination relative to each web page that the web browser loads. For another example, an offline web page modifying program may make this determination relative to a web page prior to the time that the web page is requested by a web browser. For example, the key terms may be those terms that are contained in a list of terms that previously have been deemed to be significant.

In one embodiment of the invention, for each key term so determined, a context meaning vector for that term is generated based at least in part on the body of text that contains the key term. For example, the body of text may be defined as fifty words in which the key term occurs. For another example, the body of text may be defined as a paragraph in which the key term occurs. For yet another example, the body of text may be defined as the entire web page or document in which the key term occurs.

In one embodiment of the invention, the context meaning vector for a key term is generated by applying, to the body of text that contains that key term, the same algorithm that was applied to the result documents to generate the context meaning vectors for the result documents, as described above. In one embodiment of the invention, the context meaning vector for a key term is generated by applying the Latent Dirichlet Allocation (LDA) algorithm, or a variant thereof, to the body of text.

Once the context meaning vector for a body of text has been generated, the context meaning vector can be compared with representative meaning vectors corresponding to a term contained within the body of text in order to determine the actual contextual meaning of the term relative to the body of text, as described below.

### Comparing a Context Meaning Vector to Representative Meaning Vectors

In one embodiment of the invention, in order to determine the actual contextual meaning of a term within a body of text, the context meaning vector for that body of text is compared with each of the representative meaning vectors previously generated for that term using technique described above. The meaning associated with the representative meaning vector that is most similar to the body of text's context meaning vector is most likely to reflect the actual contextual meaning of the term within the body of text.

In one embodiment of the invention, the representative meaning vector that is most similar to the contextual meaning vector of the body of text is automatically determined using a cosine-similarity algorithm. One possible implementation of the cosine-similarity algorithm is described below.

According to the cosine similarity algorithm, a similarity score is determined for each representative meaning vector that is related to the term at issue. The similarity score for a particular representative meaning vector is calculated by multiplying each of the vector values of the particular representative meaning vector by the corresponding (by position in the vector) vector values of the context meaning vector, and then summing the resulting products together. The representative meaning vector that is associated with the highest score is determined to correspond to the actual contextual meaning of the term at issue.

For example, if a first representative meaning vector contained values (A1, B1, C1), and a second representative meaning vector contained values (A2, B2, C2), and the context meaning vector for the body of text contained values (D, E, F), then, in one embodiment of the invention, the score for the first representative meaning vector (relative to the context meaning vector) would be ((A1*D)+(B1*E)+(C1*F)). The score for the second representative meaning vector (relative to the context meaning vector) would be ((A2*D)+(B2*E)+(C2*F)).

### Context-Sensitive Searching Based on Related Metadata

As is described above, in one embodiment of the invention, each representative meaning vector generated relative to a term corresponds to a meaning of that term. In one embodiment of the invention, each different meaning of a term, and therefore also the representative meaning vector corresponding to that meaning, is associated with a separate set of metadata. For example, if the term is “Boston,” then the representative meaning vector associated with the dominant seed phrase “city” may be associated with one set of metadata, and the representative meaning vector associated with the dominant seed phrase “band” may be associated with another, different set of metadata.

In one embodiment of the invention, the set of metadata for a particular meaning of a term contains information that a search engine can use to narrow, limit, or focus the scope of a search for documents that contain the term. For example, a set of metadata may comprise a listing of Internet domain names to which a search engine should limit a search for a related term; if given such a listing, the search engine would only search documents that were found or extracted from the Internet domains represented in the list. Such a domain-restricted search is called a “federated search.”

For another example, a set of metadata may comprise a listing of additional query terms. These query terms may or may not be contained in the body of text or web page that contains the term. If given such additional query terms, the search engine would only search for documents that contained the additional query terms (in addition to, or even instead of, the key term itself).

In one embodiment of the invention, a separate user interface element, such as a “Y!Q” element, is automatically inserted (e.g., by a web browser) next to each key term located in a web page. Each user interface element is associated with the metadata that is associated with the actual contextual meaning of the corresponding key term as contained in the body of text in which that key term occurs. When the user interface element corresponding to a particular key term is activated by a user, the user's web browser submits the metadata (possibly with the key term itself) to a search engine. The search engine responsively conducts a search that is narrowed, limited, or focused based on the submitted metadata, and returns a list of relevant search results. The user's web browser then displays one or more of the relevant search results to the user. For example, the relevant search results may be displayed in a pop-up box that appears next to the activated user interface element when the user interface element is activated. The user may then select one of the relevant search results in order to cause his browser to navigate to a web page or other resource to which the selected search result corresponds.

Thus, terms having multiple meanings may be automatically disambiguated. The actual contextual meaning of a term may be determined automatically, with little or no human intervention, based on training data and the contents of the body of text in which the term occurs.

### Example Flow

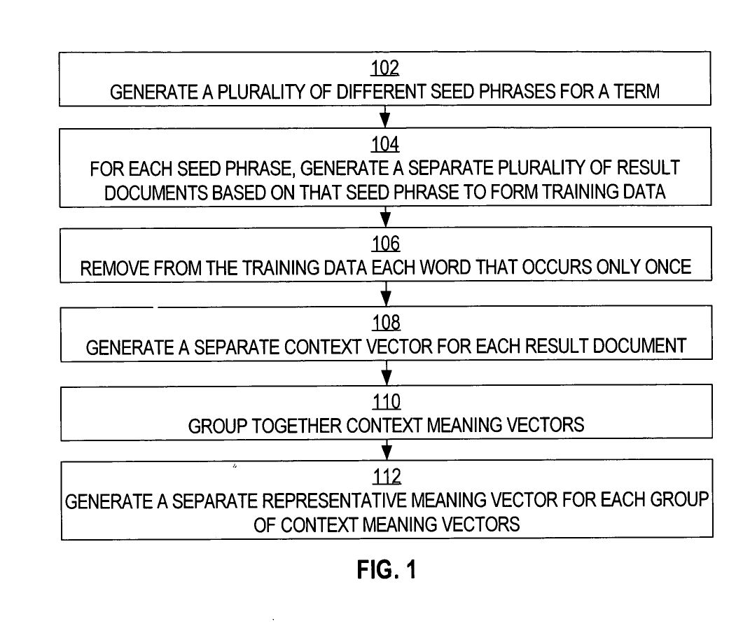

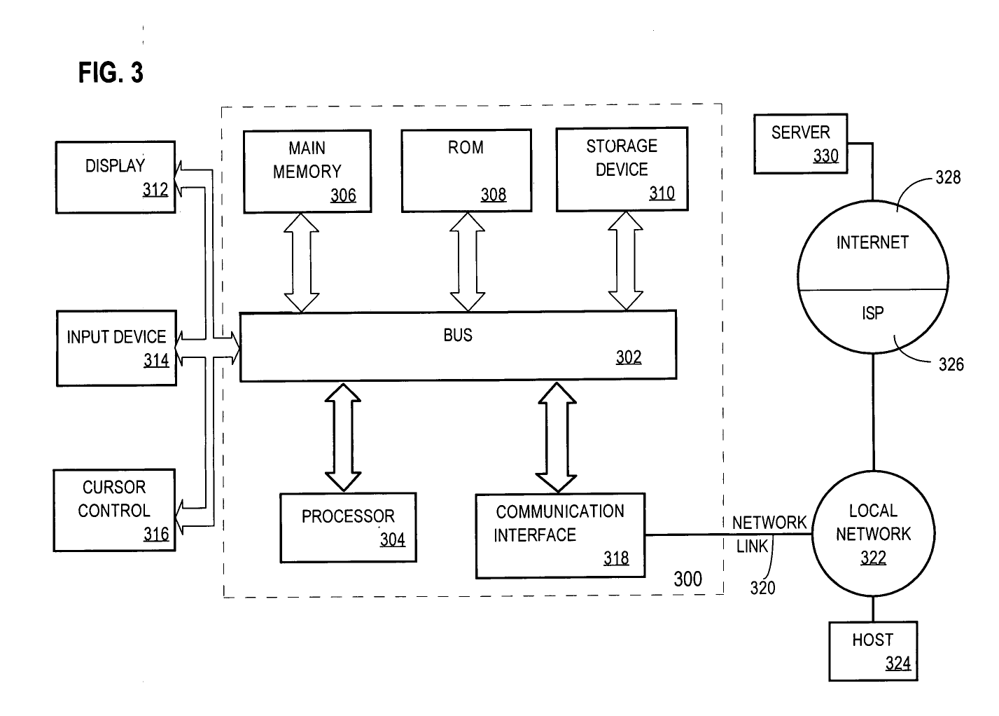

FIG. 1 is a flow diagram that illustrates an example of a technique for generating representative meaning vectors for a term, according to an embodiment of the invention. The technique, or portions thereof, may be performed, for example, by one or more processes executing on a computer system such as that described below with reference to FIG. 3.

In block 102, a plurality of different seed phrases are generated for a term. Each seed phrase corresponds to a different meaning of the term. Each seed phrase may comprise one or more words. For example, a first seed phrase for the term “Boston” might be “city,” and a second seed phrase for the term “Boston” might be “band.”

In block 104, for each seed phrase of the plurality of seed phrases, a separate plurality of result documents are generated, located, or discovered. The result documents in a particular plurality of result documents are based on a particular seed phrase of the plurality of seed phrases. For example, by submitting the query terms “Boston city” to one or more search engines (and/or the “Open Directory Project”), a first plurality of result documents may be obtained from the search engines, and by submitting the query terms “Boston band” to one or more search engines (and/or the “Open Directory Project”), a second plurality of result documents may be obtained from the search engines. As discussed above, HTML tags may be stripped from the result documents. Together, the result documents comprise the training data for the term.

In block 106, each word that occurs only once within the training data (i.e., within all of the result documents taken together) is removed from the training data. This operation is optional and may be omitted in some embodiments of the invention.

In block 108, for each result document in the training data, a separate context meaning vector is generated for that result document. For example, a context meaning vector for a particular result document may be generated by applying the LDA algorithm to the particular result document. A first set of context meaning vectors might be generated for result documents in the first plurality of result document, and a second set of context meaning vectors might be generated for result documents in the second plurality of result documents, for example.

In block 110, context meaning vectors are grouped together. For example, context meaning vectors that correspond to result documents that were located using the same seed phrase, as described above, may be placed into the same group or set of context meaning vectors.

In block 112, for each group of context meaning vectors, a separate representative meaning vector is generated for that group. For example, a representative meaning vector for a particular group may be generated by averaging all of the context meaning vectors, vector component-by-vector component, in the particular group, as described above. For example, a first representative meaning vector might be generated by averaging context meaning vectors in the first set, and a second, different representative meaning vector might be generated by averaging context meaning vectors in the second set.

Thus, a plurality of representative meaning vectors may be generated automatically for a term. The technique described above may be performed for multiple terms that occur within a body of documents, such as web pages, for example.

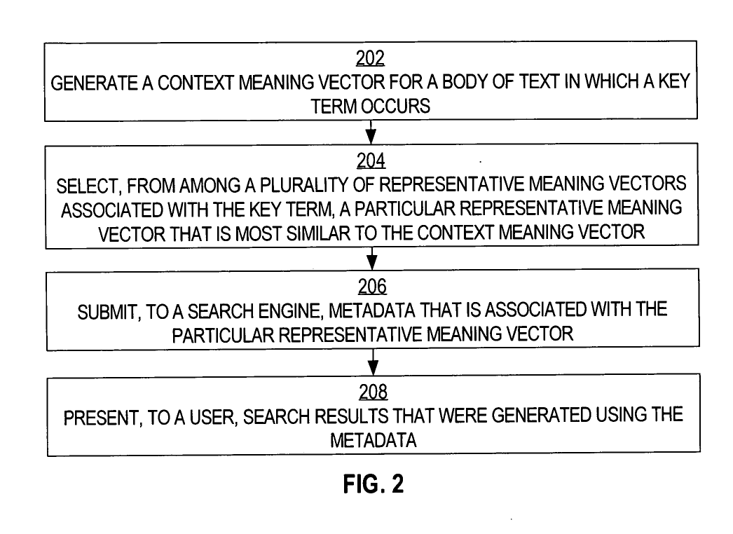

FIG. 2 is a flow diagram that illustrates an example of a technique for performing a context-sensitive search based on a term for which there exist a plurality of representative meaning vectors, according to an embodiment of the invention. The technique, or portions thereof, may be performed, for example, by one or more processes executing on a computer system such as that described below with reference to FIG. 3.

In block 202, a context meaning vector is generated for a body of text in which a key term occurs. For example, a context meaning vector for a particular body of text that contains the key term “Boston” may be generated by applying the LDA algorithm to the particular body of text.

In block 204, from among a plurality representative meaning vectors associated with the key term, a particular representative meaning vector that is most similar to the context meaning vector generated in block 202 is selected. For example, the most similar representative meaning vector may be determined based on a cosine-similarity algorithm, as is discussed above.

In block 206, metadata that is associated with the particular representative meaning vector selected in block 204 is submitted to a search engine. For example, if the metadata comprises additional query terms, the additional query terms may be submitted to the search engine along with the key term. For another example, if the metadata comprises a set of Internet domains, the Internet domains may be indicated to the search engine.

In block 208, search results that were generated based on a search performed using the metadata are presented to a user. For example, a list of relevant resources that the search engine generated using the metadata as search-limiting criteria may be displayed to a user via the user's web browser.

Thus, representative meaning vectors associated with a key term may be used in conjunction with the body of text in which the key term occurs in order to disambiguate the meaning of the key term and to perform a context-sensitive search based on the most likely actual contextual meaning of the key term.

### Hardware Overview

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
generating a first set of context meaning vectors by generating a separate context meaning vector for each document in a first plurality of documents;
generating a second set of context meaning vectors by generating a separate context meaning vector for each document in a second plurality of documents;
generating a first representative meaning vector based on context meaning vectors in the first set;
generating a second representative meaning vector based on context meaning vectors in the second set;
generating a particular context meaning vector for a body of text;
selecting, from among a set of representative meaning vectors that comprises the first representative meaning vector and the second representative meaning vector, a particular representative meaning vector that is more similar to the particular context meaning vector than any other representative meaning vector in the set of representative meaning vectors;
submitting, to a search engine, a search query that is based at least in part on metadata that is associated with the particular representative meaning vector; and
presenting search results that were generated based on a search performed based on the search query.

2. The method of claim 1, wherein the step of generating the first set of context meaning vectors comprises generating a separate context meaning vector for each document in the first plurality of documents by applying Latent Dirichlet Allocation (LDA) to each document in the first plurality of documents.

3. The method of claim 1, wherein the step of generating the first representative meaning vector comprises averaging the context meaning vectors in the first set to produce the first representative meaning vector.

4. The method of claim 1, wherein the step of generating the particular context meaning vector comprises generating the particular context meaning vector by applying Latent Dirichlet Allocation (LDA) to the body of text.

5. The method of claim 1, wherein the step of selecting the particular representative meaning vector comprises:
determining whether a first sum is greater than a second sum;
if the first sum is greater than the second sum, then selecting the first representative meaning vector as the particular representative meaning vector; and
if the second sum is greater than the first sum, then selecting the second representative meaning vector as the particular representative meaning vector;
wherein the first sum is a sum of at least a first product and a second product;
wherein the second sum is a sum of at least a third product and a fourth product;
wherein the first product is a product of at least (a) a first vector value in the first representative meaning vector and (b) a first vector value in the particular context meaning vector;
wherein the second product is a product of at least (a) a second vector value in the first representative meaning vector and (b) a second vector value in the particular context meaning vector;
wherein the third product is a product of at least (a) a first vector value in the second representative meaning vector and (b) the first vector value in the particular context meaning vector; and
wherein the fourth product is a product of at least (a) a second vector value in the second representative meaning vector and (b) the second vector value in the particular context meaning vector.

6. The method of claim 1, wherein the step of submitting the search query comprises submitting, to the search engine, instructions that instruct the search engine to limit the search to one or more Internet domains that are specified in the metadata.

7. The method of claim 1, wherein the step of submitting the search query comprises submitting, to the search engine, as additional query terms, one or more key concepts that are specified in the metadata.

8. The method of claim 1, wherein the metadata comprises information that, when submitted to the search engine, causes the search engine to narrow the search to documents that pertain to a particular meaning of a word in the body of text, wherein the word is associated with multiple different meanings.

9. The method of claim 1, wherein said instructions are instructions which, when executed by the one or more processors, additionally cause the one or more processors to perform the steps of:
generating the first plurality of documents by selecting, from a set of documents, documents that contain both a particular term and a first set of one or more words; and
generating the second plurality of documents by selecting, from the set of documents, documents that contain both the particular term and a second set of one or more words that differs from the first set of one or more words.

10. The method of claim 9, wherein the step of generating the first set of context meaning vectors comprises:
for each word in the set of documents, (a) determining whether that word occurs at least twice within the set of documents, and (b) removing that word from a document in which that word occurs if that word does not occur at least twice within the set of documents; and
generating a separate context meaning vector for each document in the first plurality of documents by applying an algorithm to each document in the first plurality of documents;
wherein the first plurality of documents comprises at least one document from which a word has been removed.

11. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
determining whether a body of text is more similar to documents in a first plurality of documents or documents in a second plurality of documents;
if the body of text is more similar to the documents in the first plurality of documents than the documents in the second plurality of documents, then selecting a first meaning as a meaning of a word in the body of text; and
if the body of text is more similar to the documents in the second plurality of documents than the documents in the first plurality of documents, then selecting a second meaning as the meaning of the word, wherein the second meaning differs from the first meaning; and
storing an association between the body of text and the meaning of the word.

12. The method of claim 1, wherein the step of determining whether the body of text is more similar to documents in the first plurality or documents in the second plurality comprises applying Latent Dirichlet Allocation (LDA) to (a) the body of text, (b) documents in the first plurality, and (c) documents in the second plurality.

13. The method of claim 12, wherein the step of determining whether the body of text is more similar to documents in the first plurality or documents in the second plurality comprises:
generating a first average of results of applying LDA to the documents in the first plurality;
generating a second average of results of applying LDA to the documents in the second plurality; and
determining whether results of applying LDA to the body of text are more similar to the first average or the second average.

14. The method of claim 12, wherein the first plurality of documents comprises documents from which one or more words that do not occur more than once within a set of documents comprising the first plurality have been removed.

15. The method of claim 12, wherein said instructions are instructions which, when executed by the one or more processors, additionally cause the one or more processors to perform the steps of:
submitting, to a search engine, a search query that is based at least in part on metadata that is associated with the meaning of the word; and
presenting search results that were generated based on a search performed based on the search query.

16. A method comprising performing a machine-executed operation involving instructions, wherein the machine-executed operation is at least one of:
A) sending said instructions over transmission media;
B) receiving said instructions over transmission media;
C) storing said instructions onto a machine-readable storage medium; and
D) executing the instructions;
wherein said instructions are instructions which, when executed by one or more processors, cause the one or more processors to perform the steps of:
applying Latent Dirichlet Allocation (LDA) to a body of text; and
based at least in part on results of applying LDA to the body of text, selecting a particular meaning from a plurality of possible meanings for a word contained in the body of text.

17. The method of claim 16, wherein said instructions are instructions which, when executed by the one or more processors, additionally cause the one or more processors to perform the steps of:
submitting, to a search engine, a search query that is based at least in part on metadata that is associated with the particular meaning; and
presenting search results that were generated based on a search performed based on the search query.
